(19) United States
(12) Patent Application Publication
(10) Pub. No.: US 2002/0154137 A1
(43) Pub. Date: Oct. 24, 2002

(54) Transmission of digital data from a screen

(75) Inventor: Gal Ben-David, Mitzpe Adi (IL)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: See-RT Technology Ltd., Nazareth Illit (IL)

(21) Appl. No.: 10/057,644

(22) Filed: Jan. 23, 2002

Related U.S. Application Data
(60) Provisional application No. 60/269,884, filed on Feb. 21, 2001.

(51) Int. Cl. G09G 5/02

(52) U.S. Cl. 345/596

(57) ABSTRACT

The transmission of digital data from a screen to a receiver is implemented by display of the digital data as a first representation of dither patterns on the screen and reception of that digital data on the receiver as a second representation.

For transmission, the receiver, equipped with a photo-detector for reception, is positioned in front of and in the field of view of the screen. Dither patterns enable reception from any kind of screen, either CRT screen, LCD screen, OLED screen, back-lit screen, or plasma screen, regardless of operation as a computer monitor or a TV screen. A first portion of the screen may be reserved as a window for data transmission, while a second portion retains regular display features.

The screen and the receiver are either portable or static.

### BACKGROUND

The present invention relates to data transmission and in particular, to digital data transmission via a display device to an optical receiver.

The idea of transmission of data from a screen is well known and covered by numerous patents, such as described for example, in U.S. Pat. Nos. 5,488,571, 5,535,147 and 6,852,615 to Jacobs et al., U.S. Pat. No. 5,570,297 to Brzezinski et al., U.S. Pat. No. 5,652,602 to Fishman et al., U.S. Pat. No. 5,801,664 to Seidensticker et al., U.S. Pat. No. 6,852,615 to Holo et al., that all contain lists of further inventions and additional citations, all enclosed herewith in whole by incorporation.

However, none of those listed inventions is able to operate a receiver with other than CRT-driven screens. None of those disclosed patents are thus operable with LCD-screens, OLED screens, backlit screens, and plasma screens. Since the archaic CRT technology may soon become obsolete, there is thus an increasing need to provide an improved capability for digital transmission able to function with all the screens presently on the market.

Moreover, the above-mentioned patents do not provide for the communication of data from an image of a screen. There is thus no way to use a receiver to capture information from a projection of a screen.

### SUMMARY

A method, an apparatus and a system are presented to enable the transmission of digital data from either a CRT, or LCD, or any other available screen, in operative association with an appropriate receiver.

In parallel, a way for a receiver to capture data from an image of a screen, such as a projection thereof, is also divulged.

Furthermore, there is disclosed a mode of operation facilitating the communication of digital data from a transmitter screen, without requiring the dedication of the entire display area of the screen of the display device to that end.

There is provided a transmission method for transmitting digital data from a transmitter to a receiver, the transmitter comprising a screen and the method comprising the steps of displaying the digital data on the screen as a succession of at least one pattern defining a first representation. Then, the method derives from the screen a second representation representative of the first representation, by configuring the at least one pattern of the first representation to comprise at least one dither pattern.

The method operates with any screen selected from the group of screens consisting of CRT screens, LCD screens, OLED screens, backlit screens, and plasma screens.

The method further provides for the integration of a low-pass-filter in the receiver for removal of high frequency scanning effects, enabling the receiver for reception of digital data from a screen selected from the group of screens. Furthermore, it is possible to derive at least one image from the first representation, and to derive the second representation from the at least one image.

There is provided a transmission method for configuring each at least one dither pattern to comprise a predetermined level of luminance selected from the group consisting of a distribution spanning the range from 0% to 100% of luminance level. The method further derives the second representation in linear proportion to the predetermined level of luminance of each one of the at least one dither pattern. It is possible to configure each at least one dither pattern to comprise a combination of M dither patterns, where M is at least 2. It is appreciated that log₂M information bits are carried in each dither pattern, which are displayed with a predetermined mutually different level of luminance selected from the group consisting of a distribution spanning the range from 0% to 100% of luminance level.

In practice, the method provides for the configuration of the first representation to comprise a combination of four dither patterns where each one of the four dither patterns carries two bits of data. The method provides for configuring each one of the four dither patterns with a predetermined mutually different level of luminance.

In the alternative, the method provides for the configuration of the first representation to comprise a combination of eight dither patterns, wherein each one of the eight dither patterns carries three bits of data. Further, each one of the eight dither patterns is configured with a mutually different level of luminance.

The method is able to provide for the definition of the screen as an entire display surface, and for the configuration of the entire display surface for display of the at least one first representation. Moreover, the method is used for defining the first representation to comprise more than one first representation, and for configuring the entire display surface for simultaneous display of more than one first representation. It is thereby feasible to display simultaneously a number of first representations in the first portion of the screen, and to display simultaneously a number of presentations in the second portion of the screen.

There is also provided for the operation of the transmitter and the receiver, in combination, in either one of two configurations consisting of a static configuration and a portable configuration.

Further provided is a receiver with a feedback signal emission mechanism for confirmation of operation of the transmitter in association with the receiver. It is also shown how to operate in at least one transmission phase, from the transmitter to the receiver, and to associate a mutually different feedback signal with each at least one transmission phase.

There is provided for a transmitter apparatus comprising a processor coupled to a memory storing a processor-readable program and a screen coupled to and driven by the processor for display of digital data originating from a data source, for transmission via the screen of the digital data to a receiver comprising a photo-sensor. The transmitter comprises a first representation of the digital data configured for display on the screen as a succession of at least one pattern. The receiver comprises a second representation being derived from the screen and being representative of the first representation, wherein the first representation is configured to comprise at least one dither pattern.

There is provided a system comprising a transmitter with a screen operating in association with a receiver comprising a photo-sensor positioned in front of and in a field of view of the screen, for the receiver to receive digital data displayed on the screen. The system comprises, at the transmitter, a first representation of the digital data configured for display on the screen as a succession of patterns, and at the receiver, a second representation being derived from the screen and being representative of the first representation, wherein the first representation is configured as a succession of dither patterns.

### BRIEF DESCRIPTION OF THE DRAWINGS

In order to understand the invention and to see how it may be carried out in practice, preferred embodiments will now be described by way on non-limiting example only, with reference to the accompanying drawings, in which:

FIG. 1 is a block-diagram of a transmitter and of a receiver,

FIG. 2 is a detail of a single block of FIG. 1, showing a transmission window for a computer monitor,

FIG. 3 is a detail, similar to FIG. 2, but specifically showing a transmission window for a TV set,

FIG. 4 is a graph related to the reception of light signals, as shown in FIG. 1, when derived by a photo-sensor from Gray Levels and from Dither Patterns displayed on an LCD screen,

FIG. 5 is similar to FIG. 4, but with respect to a display on a CRT-driven screen,

FIG. 6 presents a sample of a Gray Level and of a Dither Pattern, for which FIGS. 4 and 5 compare reception,

FIG. 7 shows four dither patterns with a luminance level distribution selected from the range spanning from 0% and 100% of luminance level,

FIG. 8 provides an illustration of a Differential Pulse Code Modulation method for the transmission of data when using four dither patterns, each one carrying two bits of digital data,

FIG. 9 is a more detailed block-diagram of the receiver depicted in FIG. 1,

FIG. 10 shows data transmission between an LCD screen from a laptop computer and between a receiver, in accordance with the block diagram of FIG. 1,

FIG. 11 is a flowchart illustrating digital data transmission from an LCD screen, as depicted in FIG. 10,

FIG. 12 is similar to FIG. 10, but for data transmission from a TV set, and

FIG. 13 is a flowchart of the transmission from a TV set, as shown in FIG. 12.

### DETAILED DESCRIPTION OF THE PREFERRED EMBODIMENTS

There is divulged the capability to transmit digital data via patterns shown on a screen of a display device, irrespective of the technology driving the screen, for reception by a receiver comprising a photo-sensor. The patterns are configured to convey at least one, but preferably more than one single-bit signals of binary data.

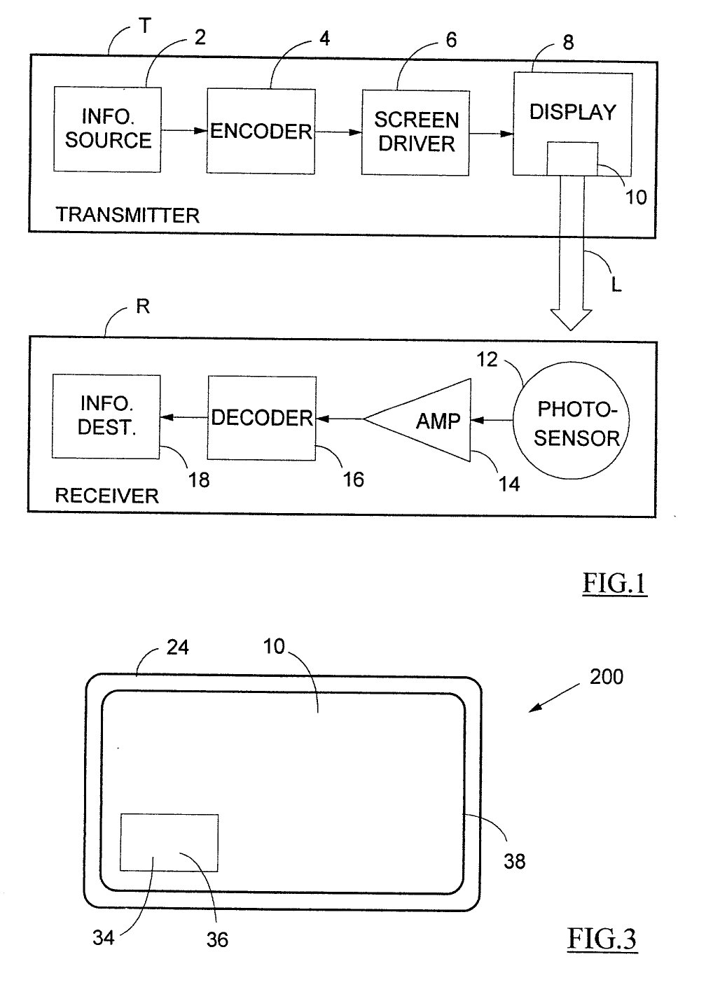

With reference to FIG. 1, there is shown a block-diagram of a transmitter T and of a receiver R. Digital data emitted by an information source 2 is forwarded, for encoding, to an encoder 4 coupled thereto. From the encoder 4, the encoded digital data passes to a screen driver 6, coupled to the encoder 4. It is the screen driver 6, coupled to a display device 8, which commands the generation of patterns on the screen 10. A screen is regarded as being the surface of a display device on which an image or a pattern is produced. Examples of display devices are TV receivers, radar receivers, computer monitors, display devices found in processor-driven instruments, in personal digital assistants, in calculators, in appliances and similar apparatus. Light, emanating from the screen 10, is symbolized by an arrow designated as L.

In principle, the receiver R comprises a photo-sensor 12, to collect the emissions of light emanating from the screen 10. It is well known that a photo-sensor 12 is a device responding to light by providing an electrical signal output in response to the light input. The photo-sensor 12, comprising optional optics, such as a lens, thus collects light signals that are converted to electric signals and then amplified by an amplifier 14. Finally, the amplified signals are decoded by a decoder 16, and reach an information destination 18, where they are stored.

The receiver R is implemented as a portable device, such as a promotional item like a key-holder, or a smart card, or is embedded in either a personal data assistant, or a wrist watch, or a toy, or a cellular phone, etc. The receiver R may also be implemented as a static device.

The information destination 18, which is a storage device that contains strings of digital data pre-loaded or downloaded from the screen 10, makes the stored digital data available for further use, such as for example, to software-driven hardware coupled thereto.

Returning now to the transmitter T, the information source is embodied either as the memory of a processor possibly coupled to a computer, or as a storage device pertaining to a network, or as an Internet, or as a wired or wireless modem. Alternatively, when the screen 10 pertains to a TV set, the information source is embodied as an appropriate TV reception antenna of any kind, or as a VCR (Video Cassette Recorder), or as a CATV (Cable Television) system. The encoder 4 translates the received digital data into information forwarded to and processed by the screen driver 6, for display as a two-dimensional pattern on the screen 10. The two-dimensional pattern is presented on either the entire surface of the screen 10 or only on a portion of the surface thereof. Such a portion defines a transmission window while the rest of the surface of the screen 10 defines an area.

It is noted that the present disclosure is practical for use with the screen 10 of any display device, such as for example, a monitor 20 for a computer, either raster scan CRT (Cathode Ray Tube), LCD (Liquid Crystal Display), OLED (Organic Light-Emitting Diode), Plasma screen, backlit screen, or for a display for a TV set 24, either a regular CRT, or a backlit screen, or any other display configured to output patterns. Furthermore, an image derived from any of those screens, such as a projection of the screen on a surface, such as a screen, allows the receiver R to derive digital data therefrom.

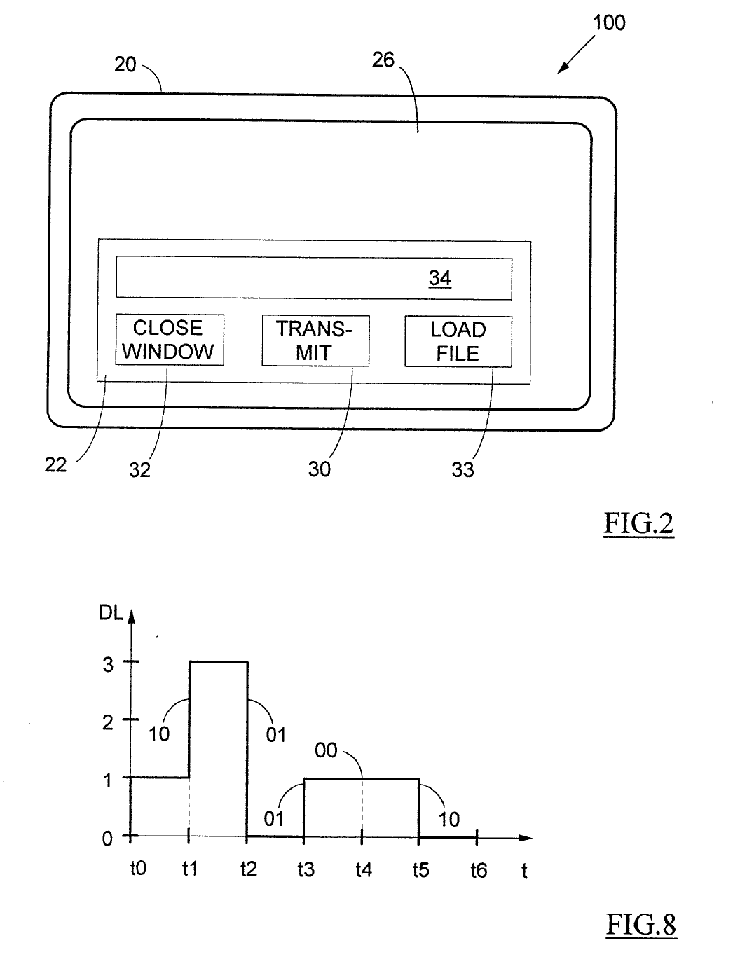

FIG. 2 illustrates an example of an embodiment 100 with a transmission window 22, in the case of a computer monitor 20 coupled to a processor or computer-driven screen 10. In the embodiment 100, only a first portion of the screen 10 is employed for and covered by the transmission window 22. Possibly, the screen 10 transmits data from the transmission window 22, while a second portion 26 of the surface of the screen, defined as an area, outside the transmission window, is available for simultaneous data presentation, such as, for example, of an application window 28.

The transmission window 22 for a computer monitor 20 may feature a “Transmit” button 30, a “Close Window” button 32, a “Load File (for Transmission) button 33, and a transmission port 34. For transmission of data from the transmitter T to the receiver R, when the transmission window 22 is shown on the screen 10, the receiver is first placed in close proximity in front of, and in the FOV (Field of View) of the transmission port 34. It is understood that the mere display of the transmission window 22 indicates that the transmitter T is ready to support and start transmission. As a second step, the “transmit” button 30 is activated.

An application computer program then presents digital information for transmission in the form of a succession of patterns, for display in the transmission port 34. After successful reception of the digital information by the receiver R, the “close window” button 32 is activated to end the transmission procedure.

It is also possible to expand the transmission port 34 to a transmission window 22 area by removing the buttons, 30, 32 and 33. Commands for the transmission process are then entered by an input device of the computer, or via an application window 28 displayed in the area 26. Evidently, either with or without buttons, 30, 32 and 33, the transmission window may cover only a portion or the entire surface of the screen 10,

FIG. 3 illustrates an embodiment 200, with the screen 10 belonging to a TV set 24, where the previously described transmission window 22, now the TV window 36, covers either the whole surface of the screen 10, not shown, or is only a portion thereof, as shown in FIG. 3. In practice, the screen 10 of a TV set 24 displays regular TV broadcasts in the TV area 38, outside of the TV window 36 in parallel with the operation of the TV window 36, as made possible by use of the Picture-in-Picture technology. Without user-to-TV interaction, no buttons are needed in the TV window, which is in fact similar to a transmission port 34.

As will be explained below, warning is given by the TV broadcast, either visually, on the screen 10 of the TV set 24, or by audio-message, or by both, that a transmission is imminent. The user is thereby urged to orient the receiver R opposite to, not farther than a predetermined distance, and in the FOV of the screen 10 of the TV set 24, for successful data reception. Graphic patterns shown on the screen 10 then generate light signals that are detected by a photo-sensor 12 operative on the receiver R.

It should be noted that neither the transmission window 22 nor the TV transmission window 36 are restricted to a rectangular shape as shown in FIGS. 2 and 3. In fact, any shape, circular, elliptic or other, is implementable.

Light Signals

A limiting factor for the transmission of light signals from a screen 10 to a photo-sensor 12, as seen in FIG. 1, resides with the non-linearity of transmission, as explained below. The encoder 4 receives digital data and processes that information into electronic signals used by the screen driver 6 to draw patterns, emitting light signals on the screen 10. Those light signals are the input detected by the photo-sensor 12 that generates output voltage signals. In turn, the output of the photo-sensor 12 is limited by constraints imposed by the transfer characteristics of the selected photo-sensor, of the type of display device and by the specific screen being used. The terms photo-sensor, photo-detector, light detector, photo-diode, photo-resistor, light-dependent resistor, photo-transistor, photo-voltaic cell and point detector are considered as being interchangeable.

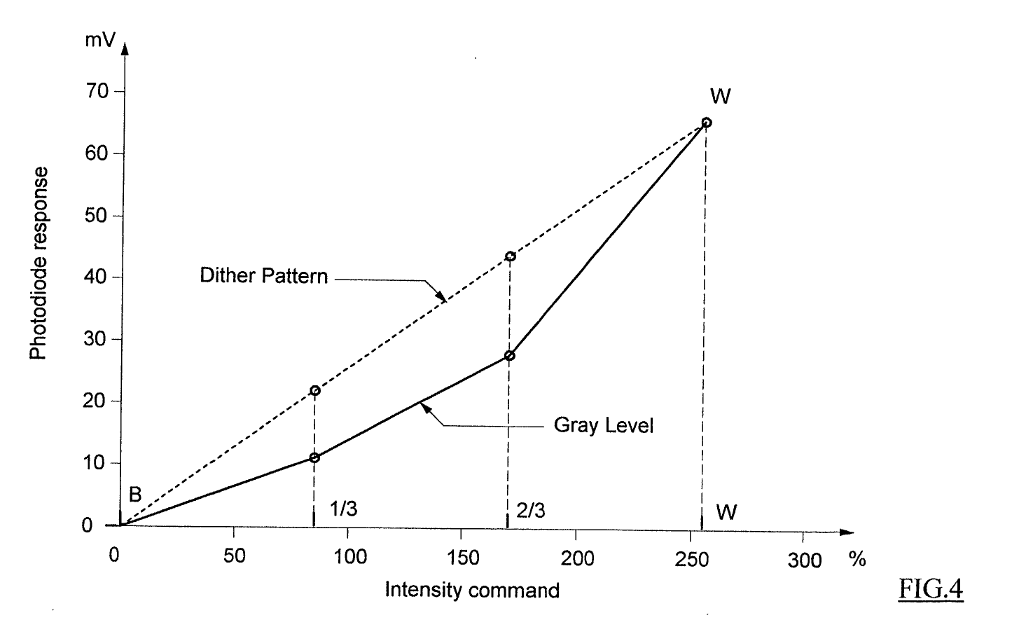

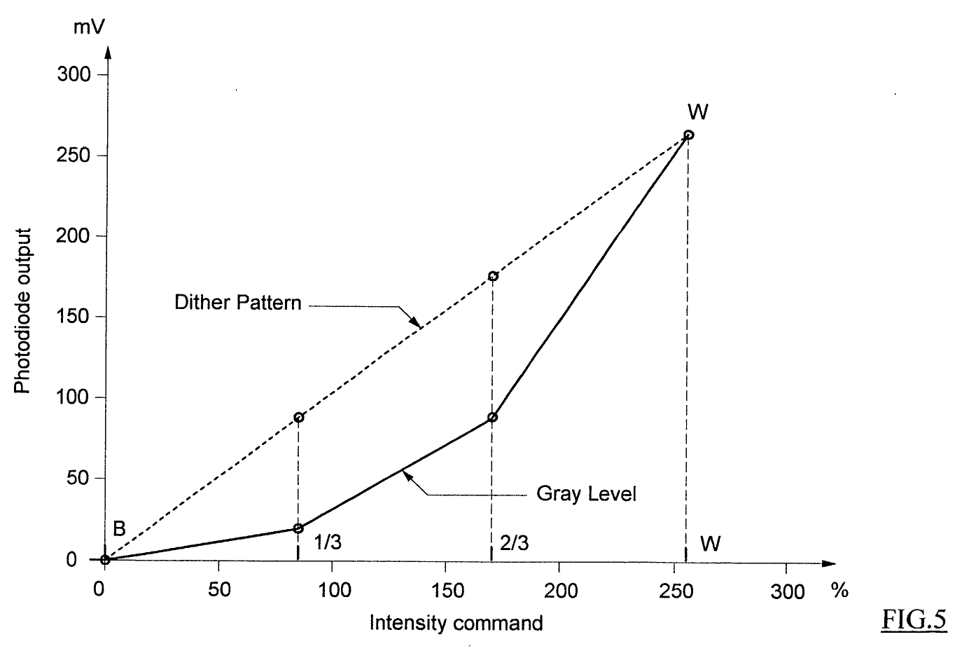

FIGS. 4 and 5 now illustrate, as an example, the response of an OPT210 photodiode manufactured by the Burr Corp., P.O. Box 11400, of Tucson, Ariz. 85734, USA, to gray level signals, ranging from completely black to fully white, for two different display devices. FIG. 4 depicts a curve denoted as GL, drawn on a CRT display screen CM715 made by Hitachi, of 2000 Sierra point Parkway, in Brisbane, CA 94005-1835, USA. In parallel, FIG. 5 shows another curve, also designated as GL, traced on an LCD display for an E500 notebook computer, produced by Compaq, of 20555 State Highway 249, in Houston, Tex. 77070, USA. Both FIGS. 4 and 5 depict the output of the photodiode OPT210 in mV vs. a gray level command ranging from a first gray level fully black B, through a second gray level 33.3% black and 66.7% white, then via a third gray level 66.7% black and 33.3% white, to end finally in a further gray level 100% white W. These four levels are designated in FIGS. 4 and 5 as, respectively, B (black), 1/3W, 2/3W, and W (white).

The non-linearity of the output of the photo-sensor 12 with respect to the value of the intensity of the control signals for the curves GL is clearly perceptible in the FIGS. 4 and 5. This non-linearity imposes an unnecessary complication, and requires the application of a compensation function, on the data transmission at either the transmitter or the receiver. Since the non-linear response of the same photo-sensor 12 also varies from screen to screen, it is impossible to implement a single compensation function. Therefore, it is preferable to choose an alternative implementation permitting to achieve linear output response from the photo-sensor 12. Furthermore, since binary gray level, e.g. black and white, permits only sequential single bit signal communication, it is also preferable to select a method allowing simultaneous multiple bit transmission, to shorten the duration of the transmission.

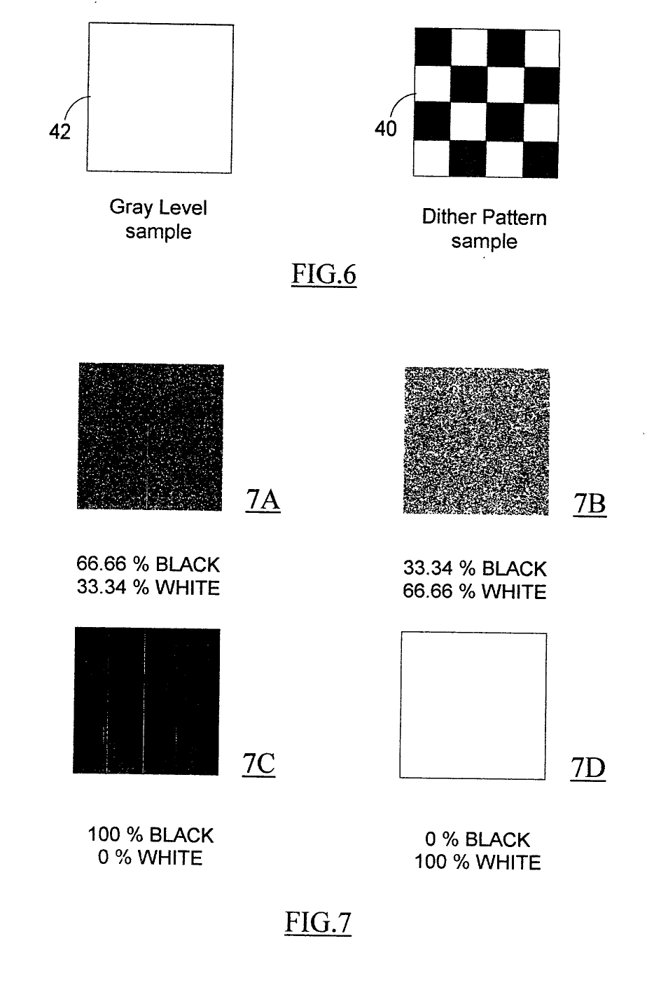

Such an alternative is offered by the adoption of dither patterns. With reference to FIG. 1, the screen driver 6 processes the digital signals received from the encoder 4, for display as dither patterns. An enlarged sample of a dither pattern 40 is exhibited in FIG. 6 in comparison with a sample of a gray level 42 of the same level of average luminance. Dither patterns 40, are a substitute method for the representation of gray levels 42, and consist of a combination of black and white pixels.

Dither patterns 40 are thus used here, instead of gray levels 42, to improve the linearity of the optical transmission. To create a dither pattern 40, average luminance levels are implemented by random patterns of black and white pixels. The dither patterns 40 may be generated, either during transmission, or created once, kept in memory, and copied to the screen 10 as needed.

For each pixel in the area that should show a dither pattern, a random number is uniformly distributed in the interval [0, 1]. The number is compared with a predefined threshold. For example, a 33% white and 67% black pattern is made by a 0.33 threshold and a white, or alternatively black, pixel is drawn if the random number is, respectively, lower, or greater than the threshold.

In operation, a photo-sensor 12, mounted on the receiver R of FIG. 1, collects light L from a window, either a transmission port 34, or a transmission window 22, or a TV transmission window 36, or from the whole screen 10. “Window” is the general term for a portion of the screen 10, monitor or TV, that displays patterns for transmission. That light L is received as an average of the illumination level. The response current or voltage amplitude emitted by the photo-sensor 12 is closely proportional to the average of the light L obtained from the patterns displayed on the screen 10. For a computer monitor 20, the response of the photo-sensor 12 is linearly relative to the light emitted from all the pixels in the FOV thereof. Therefore, an image consisting of 50% black pixels and of 50% of white pixels, shown as the dither pattern 40, produces a response signal very close to the middle of the output range of the photo-sensor 12. A different combination of black and white pixels will evidently provide other results, but the response of the photo-sensor 12 will remain linearly proportional to the luminance level of the displayed pattern.

Levels of luminance of dither patterns span a distribution ranging from 0% to 100%. The level of luminance of a completely black dither pattern is 0% and that of a completely white dither pattern is 100%.

FIG. 7 shows four different dither patterns designated as 7A, 7B, 7C, and 7D. The dither patterns 7A and 7B depict, respectively, a dither pattern with a first distribution of 66.66% of black pixels and 33.34% white pixels, and a second distribution of 33.34% of black pixels with 66.66% white pixels. FIG. 7C is regarded as a dither pattern with a combination of 100% black with 0% white pixels and FIG. 7D is the negative, thereof, thus with 0% black and 100% white pixels.

The OPT210 photo-diode response, in mV, for the four different dither patterns shown in FIG. 7, is presented in FIGS. 4 and 5 as a curve DP for respectively, a CRT screen and an LCD screen. The output of the OPT 210 detector ranges from zero mV for completely black B, to about 260 mV for completely white W, for this specific example. The two intermediate dither patterns, 7A and 7B in FIG. 7, with 1/3 white and with 2/3 white pixels, complete the curve DP to form a practically linear output curve. A comparison of the dither pattern curve DP to an according gray level curve GL, in both FIGS. 4 and 5, distinctly emphasizes the improvement achieved by the use of dither patterns.

Data Transfer

It is possible and easy to transfer a string of digital data by help of at least four signals. First, a couple of signals to identify respectively, the beginning and the end of the communication string, and second, two more signals to correspond to 0 and 1. For example, four different dither patterns may be used to this end. Evidently, data transfer rate benefits when more than four dither patterns are used, as will be explained below.

With four dither patterns, each one with his own predetermined and mutually distinct level of luminance, spanning from complete black to full white, one may consider a constant-time communication rate, thus a sequence of consecutive time frames where each dither pattern may represent two binary bits: 00, 01, 10 and 11. Each time frame on the screen presents one dither pattern having one distinct level of luminance. As a very simple example, 2ⁿ dither patterns, with n=2, are considered. There are thus four dither patterns, able to represent the four binary numbers 00, 01, 10, and 11. Thereby, each single dither pattern carries 2 bits of binary data. Each dither pattern comprises a distinct and mutually different level of luminance selected from the distribution of luminance levels ranging from 0% to 100%. Two dither patterns, say 00 and 11, may correspond, respectively, to the beginning and to the end of a communication of digital data, while 01 and 10 may correspond to the values 0 and 1. This method is recognized as PCM (Pulse Code Modulation).

In another implementation, again with four dither patterns, thus four levels of luminance, still with data transmission at a constant-time communication rate, the transmitted digital data are encoded as the difference between the representation of two successive dither patterns. As above, each dither pattern represents two binary bits of data designated as L={0, 1, 2, 3} with for example, 0 for complete black and 3 as full white. In addition, the four different couples of information are labeled as I={0, 1, 2, 3}. Assuming that at a certain time a specific dither pattern is exhibited on the screen 10, then, to indicate a new value of digital data I, the next time frame will put on display a dither pattern of (I+L) mod4, where mod4 is a modulus 4 calculation. This method is recognized as Differential PCM, and is more robust to constant ambient light.

Reference is now made to FIG. 8, showing an abscise for the time sequence t=t1, t2, . . . tn, and an ordinate for the values of the dither patterns DP=(0, 1, 2, 3), representing the binary data values of, respectively 00, 01, 10 and 11. At time t1, the passage from the DP=1 to the DP=3 indicates the emission of the binary value 10. Then, at time t2, with DP=3, the binary value 01 is sent, resulting in DP=0, in accordance with modulus 4 calculation. At time t3, 01 is again emitted, but at time t4, since there is no difference in the DP, 00 is communicated. Next, to communicate the binary data 11 at time t5, DP=0 is displayed. As explained earlier, one pair of dither patterns may be reserved for both the beginning and end signals of a transmission string, while the other pair is set aside for the digits 0 and 1. However, a start stamp and an end stamp are practical and are implemented in many communication methods, for example, as respectively, a string of eight digits 11 and of eight digits 00. Data integrity and other checks may also be transferred before the end of the transmission procedure.

The duration of the constant time frame Δtn=tn−t(n−1) is chosen in accordance with the characteristics of the screen 10. Each display device requires a minimal delay, as response time, for passage from white to black, and vice-versa. The detection circuit of the decoder 16 also requires some additional delay. The slow response time of LCD screens is an impediment to fast communication rates and therefore, a motivation to use dither patterns carrying a plurality of digits. By doing so, the detrimental rate of communication of LCD screens is greatly improved. For an LCD display, this screen response time ranges from at least 15 ms to at most 45 ms. Therefore, for a time frame of some 50 ms, it is thus possible to transmit two binary bits at a rate of 20 Hz totaling 40 bits per second. The precise timing of the display of the dither patterns depicted on the screen is of crucial importance for successful communication between the transmitter T and the receiver R.

It is possible to configure each at least one dither pattern to comprise a combination of M dither patterns, where M is at least 2. It is appreciated that log2 M information bits are carried in each dither pattern. For example, in a combination of M dither patterns, to represent M binary numbers, each dither pattern carries x=log2 M bits of binary data. For eight dither patterns, thus for M=8, each dither pattern carries 3 bits of digital data. It is also noted that log2 M is possibly a non-integer, as taught by Andrew J. Viterby and James K. Omura, in “Principles of Digital Communication and Coding, Chapter 1, pages 7-19, Published by McGraw-Hill Companies, 1979, ISBN: 0070675163, which is incorporated herewith in whole by reference.

It is also possible to take advantage of the duration of a time frame to convey information. For example, a short duration may be associated with the bit 0 while a long duration may represent the digit 1.

Receiver

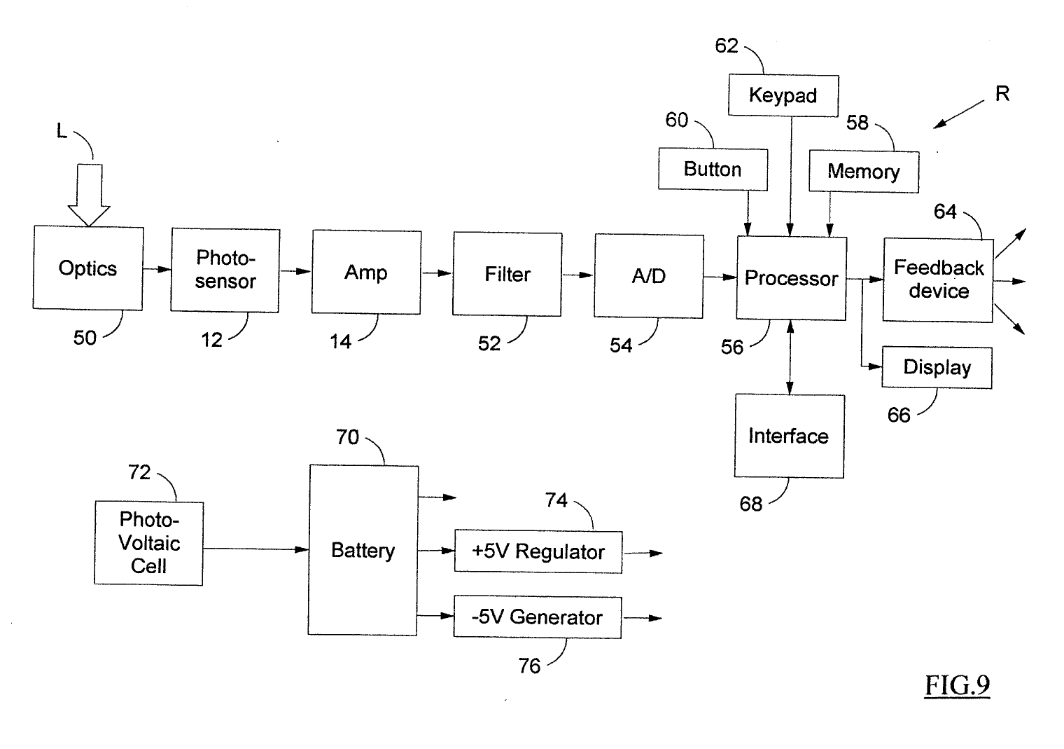

FIG. 9 presents a more detailed block-diagram of the receiver R. The photo-sensor 12, is possibly preceded by optics 50 coupled thereto and aimed at improving the collection of light signals L. For example, the optics 50 may narrow the FOV of the photo-sensor 12 to focus on light emitted by a small transmission window 22 on a screen 10, and prevent interference form light emanating from other portions of that same screen. As another example, the optics 50 may be configured to receive signals from a TV window 36, displayed by a TV set 24, to permit a user to receive data even when the receiver R is located at distance from the screen 10. Furthermore, the optics 50 may comprise optical filters and/or coated optics to filter undesired radiations.

In FIG. 9, the photo-sensor 12 is coupled to an amplifier 14, and provides thereto an output in the form of analog electric signals, for amplification. In turn, the amplified signals pass through a low-pass-filter 52 coupled to the amplifier 14 and to an A/D device 54 also coupled to a processor 56. The purpose of the low-pass-filter 52 is to remove high frequency scanning effects, bringing both LCD screens and CRT-screens to a common reception principle. The low-pass-filter 52, typically at 30 Hz, filters-out both ambient light and the screen refresh rate, of 50/60 Hz and of 100/120 Hz. It is appreciated that the filter may be implemented either by analog processing means of by a Digital Signal Processing software program running on the processor 56.

Still with reference to FIG. 9, the processor 56 decodes the digital data received from the A/D device 54 and stores the data received from the screenl O in a memory 58, coupled to the processor. A receive button 60 and a keypad 62 coupled to the processor 56 are possible input devices to the receiver R. A feedback device 64 and a receiver display 66, also coupled to the processor 56, are possible output devices. Moreover, an interface device 68, coupled to the processor 56, makes it possible to couple the receiver R to external devices (not sown in FIG. 9) such as other processors, drivers, controllers, motors, etc.

The receiver R, when of the portable type, is powered by a battery 70, or by a photovoltaic cell 72, or by a combination of a photovoltaic cell used to recharge the battery 70. For example, the battery may comprise a couple of button-sized lithium batteries, not shown in the Figs., coupled to the analog circuitry, and coupled also with a +5V regulator 74 and with a −5V generator 76 for energizing respectively, the digital circuitry and the LCD bias voltage, when the receiver R comprises a receiver display 66.

In practice, the receiver R is implemented either a promotional item such as a key holder, or a smart card, thus as a wallet-sized portable receiver, or is embedded in a wristwatch, or in a toy, or in a cellular phone, and the like. The photo-sensor 12, with a lens and an amplifier 14, may even be purchased off-the-shelf, packaged in a single miniature unit, as catalogue number IPL 10530AAL, from the IPL 10530 Series of High Sensitivity Low Speed Integrated Photo-amplifiers made by Integrated Photomatrix Ltd., of Dorchester, Dorset, U.K. The processor 56 is possibly a microchip 16C773 made by Microchip Technology Inc., 2355 West Chandler Blvd., Chandler, Ariz. 85224-6199 which features an embedded A/D converter. In a minimal configuration, the processor 56 is coupled to only a memory 58, a receive button 60 and a feedback device 64. Although many variations are possible, a buzzer, or an audible feedback device, work very well.

A feedback signal is understood as any signal detectable by a mechanism or function by which a human person is receptive and responsive to a particular stimulus or class of stimuli arising externally, such as in the case of the senses of sight, hearing, smell, taste, touch, temperature and pain. Practically, feedback signals are either audible, or visual, or tactile or vibratory.

Operation

The transmission of digital data requires a signal source, a display device with a screen 10 as a transmitter, such as a computer monitor 20 for a computer or a TV set 24, and a receiver R such as a portable hand-held device. The situation may also be reversed, where the transmitter screen 10 is portable and the receiver is static, or otherwise when both receiver the R and transmitter the T are portable.

Assuming that transmission signals is ready for operation, the operation of the receiver R comprises a first positioning phase, a second manipulation phase, and a third actual reception phase of the transmission. Although being the same in principle, the necessary interaction of the user for the reception of digital data emitted by a screen 10 for a computer monitor 20 may be different in details, from the reception of digital data emanating from a TV set 24.

Reception from a Computer Monitor

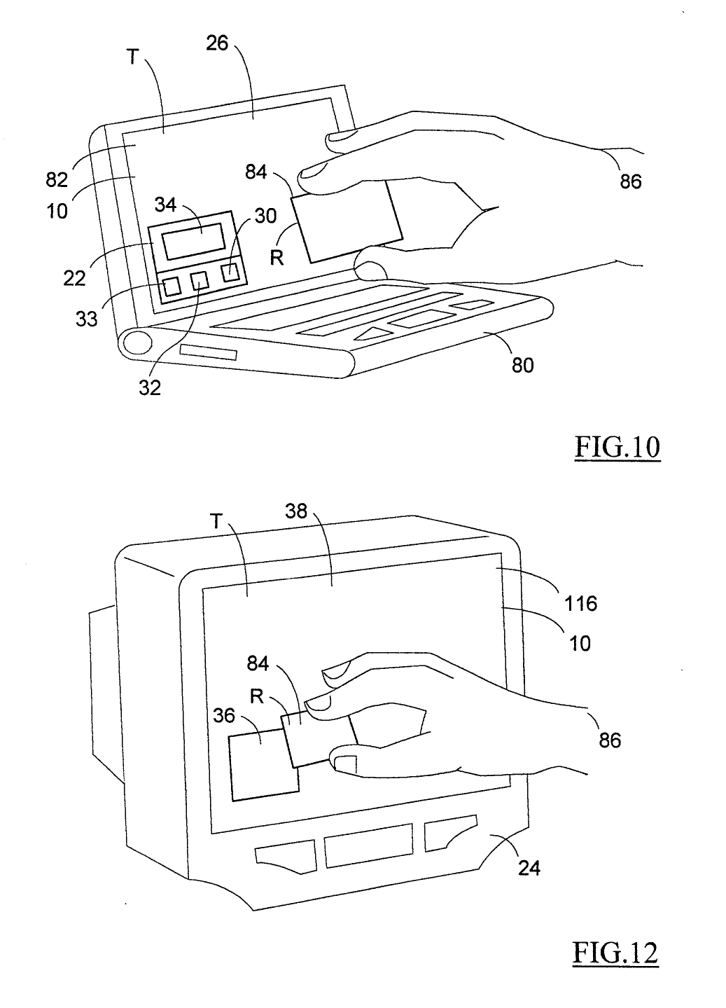

FIG. 10 shows a laptop computer 80 with a screen 10, such as an LCD screen 82, and a hand-held receiver R, shown in FIG. 9, depicted as a smart-card 84, positioned by a user 86 in predetermined mutual spatial relationship with the LCD screen 82, for communication with a transmission window 22 exhibited on the LCD screen. The LCD screen 82 may display the transmission window 22 on the entire surface of the screen, or only on a portion of the surface of the screen. Evidently, the LCD screen 82 may also be replaced by a screen of any type. Similarly, the smart-card 84 may be equipped with any photo-sensor 12, configured to receive digital data configured as dither patterns 40 from a screen 10.

The user 86 presents the receiver R, or here the smart-card 84, in front of, and close-by to the transmission window 22 and ascertains that the photo-sensor 12, not shown in FIG. 10 but mounted on the smart-card, is positioned in the FOV (Field of View) of the transmission window.

The computer monitor transmission program is now operated on the transmitter T, here the laptop computer 80 and uploads a text or binary file for transmission when the “load file” button 33 is activated. By this activation, a computer program running on the laptop computer 80 loads the digital data for transmission and restructures that digital data according to the predetermined coding of the dither patterns. For example, if the digital data for transmission is stored in the hard-disk of the laptop computer 80 as bytes, then that computer program must reconfigure the digital data as couples of bits, to conform with for example, a transmission method using four dither patterns. Evidently, when the transmission uses eight dither patterns, then the computer program separates the bytes in groups of three bits. In general, for 2ⁿ dither patterns, the computer program separates the bytes into groups of n bits. For actual transmission the dither patterns are then presented in succession on the screen 10. Error correction/detection codes may also be added at this point.

After completion of the positioning phase, the manipulation phase now starts.

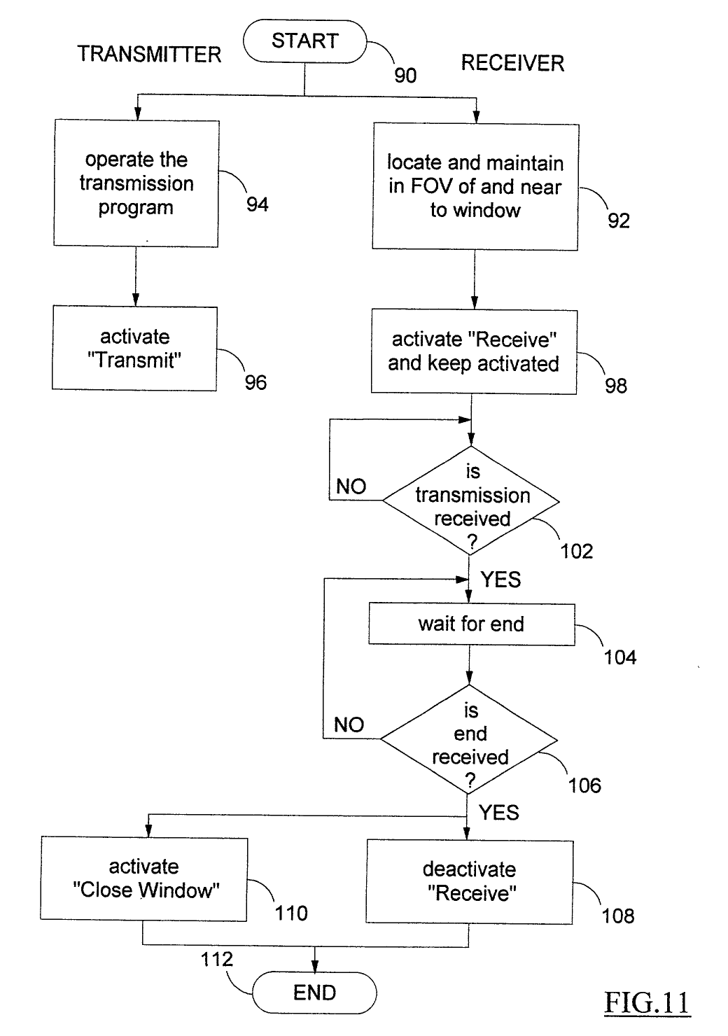

For the user 86, the operation of the system is straightforward and simple. The following example relates to a laptop computer 80 with an LCD screen 82 but the operation is the same for any other computer with a screen 10 of any kind. With reference to the simplified flowchart in FIG. 11, the steps taken by the user 86 are listed top-down for both the transmitter T, in the left column, and for the receiver R, in the right column, from the start 90 to the end 112 of the computer monitor transmission process. Step 92 relates to the positioning phase of the receiver R, as described above, and requires that the receiver R be located and maintained in the FOV and proximate to the transmission window 22. Next, in parallel in 94, the user 86 operates the transmission computer program on the laptop computer 80 to transmit data from the LCD screen 82 to the receiver R.

The user 86 now starts, see step 96, the transmission of the digital data by activating the “Transmit” button 30, shown in FIG. 10. In turn, in step 98, the “Receive” button 60 (in FIG. 9) on the receiver R is activated and held activated for the whole duration of the transmission process. The receiver R is now ready to capture a succession of dither patterns displayed on the LCD screen 82. The receiver R first checks, in step 102, which transmission is successfully received and if not, loops back and waits until success is achieved. In step 104, the receiver R waits for the end of the transmission. During transmission, dither patterns 40 are displayed in succession in the transmission window 22, while other presentations may be made simultaneously in the area 26 outside the transmission window 22.

Each dither pattern 40 is displayed in sequence for a predetermined length of time that may last between 30 and 100 ms, for a typical LCD screen 82. The succession of patterns, thus the string of digital data of the transmission, is repeated for a predetermined number of times unless interrupted by the user 86, to which the successions of dither patterns appear as a series of flashes.

When the receiver R, i.e. smart-card 84, detects that the end of the transmission process, thus that the string of digital data is correctly received, as in step 106, a transmission-end feedback signal is emitted by the receiver R for the user 86 to perceive. For example, such a feedback signal is a beep, emitted once or in cycles. Different feedback signals, such as beeps or various frequencies or of various tones, may represent singular stages of the transmission process such as e.g. “wait for data in process” or “data received”. If the end of the transmission is not detected, then control loops back to wait for that end, in step 104, and for making another check, in step 106.

As shown in step 108, the user 86 may now deactivate the receive button 30, and may remove the receiver R from the FOV of the transmission window 22. On the LCD screen 82, the succession of dither patterns will continue for as long as the “Close Window” button 32 is not deactivated. Therefore, the user is anticipated to manipulate the “Close Window” button 32, in FIG. 10, as per step 110. This last step 110 terminates the display of the window 22 and stops the digital data transmission process. It is noted that the string of digital data cycles continuously on the screen 10, until stopped by use of the “Close Window” button 32. The transmission process now reaches the end, in the last step 112.

Actually, when the transmission window 22 does not comprise buttons, the operation is similar since the buttons, or an equivalent thereof is then located outside of the transmission window or implemented by operation of input commands to the laptop computer 80.

The steps taken by the user 86 to operate the transmission process for a computer monitor 20 with a screen 10, either LCD, or CRT, or OLED, or plasma, are the same, whether the data for transmission originates from a computer, a network, an Internet or another computer-driven source.

Reception from TV Set

With reference to FIG. 12, a TV set 24 with a screen 10, as a transmitter T, designated as a TV screen 116, is shown with a receiver R in the form of a smart-card 84 held by a user 86 in front of a TV window 36. Again, the operation cycle consists of a positioning phase, a manipulation phase, and a transmission phase. As explained above in relation with the LCD screen 82, the spatial positioning and relationship between the TV window 36 and the receiver R must be carefully observed.

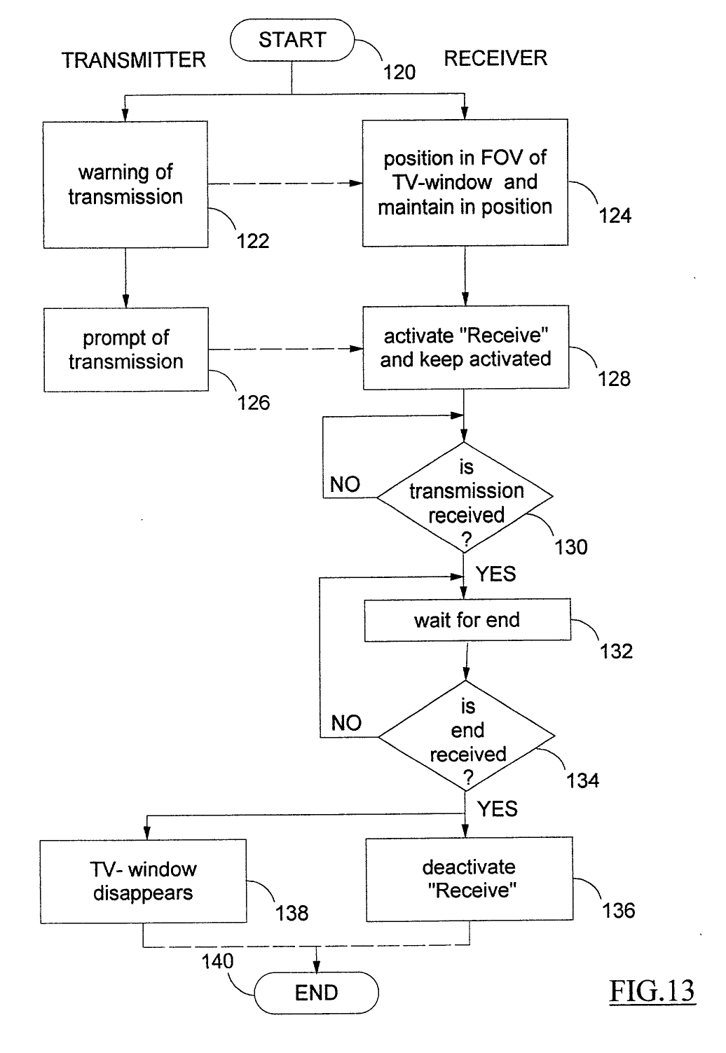

For the user 86, the operation of the system is straightforward and simple. With reference to the simplified flowchart in FIG. 13, the steps taken by the user 86 are listed top-down in a middle column, with the transmitter T in the left column, and the receiver R in the right column, from the start 120 to the end 140 of the TV transmission process.

Without interactive capability with the TV broadcast, the user 86 is slaved to commands displayed on the TV window 36. Reference is now made to FIG. 13 beginning with “start” as the first step 120. Step 122 relates to the positioning phase, as a warning shown by the TV broadcast, in the TV area, that a transmission is imminent, indicating to the user 86, in step 124, to appropriately position the receiver R in front and in the FOV of the TV window 36. The user 86 holds the receiver R in position, waiting for a prompt indicating the beginning of the transmission.

Step 126 refers to a prompt, either visual or audio, or both, indicating the beginning of transmission. In response, in step 128, the user 86 activates the receive” button 60 (in FIG. 9) on the receiver R, and holds that receive button activated for the whole duration the transmission process. The receiver R responds to the check in step 130, by a feedback signal indication that the transmission is received. Should this not be the case, then control loops back for another check in step 130. The user 86 now waits for the end of the transmission, by step 132. The receiver R is now ready to capture the succession of dither patterns displayed on the TV screen 116. The user 86 perceives the transmission as a series of flashes on the screen 10. Dither patterns are now displayed in succession in the window 36, while other TV broadcasts may be presented simultaneously on an area of screen 116, outside of the TV window 36.

Each dither pattern is displayed in succession for a predetermined length of time that may last between 10 and 100 ms, according to the type of screen 116, for example, either CRT, or LCD, or OLED, or plasma screen, or back-lit, or any other type. The succession of dither patterns, thus the digital data for transmission, is repeated for a predetermined number of times.

When the receiver R, i.e. smart-card 84, detects that the end of the transmission message is correctly received, as in step 134, a transmission-end feedback signal is emitted by the receiver R for the user 86 to perceive. Else, control loops back, for another wait for the end of reception, in step 132. As shown in step 136, the user 86 may now deactivate the receive button 30 and may also remove the receiver R from the FOV of the TV transmission window 36. The succession of dither patterns will continue for as long as predetermined, and then stop, for the TV window to disappears, in step 138, thereby reaching the end of the transmission process in step 140. It is remembered that there is no interaction from the receiver R to the TV broadcast.

The steps taken by the user 86 to operate the transmission for a TV set driven screen 10, either CRT or LCD are the same, whether the data for transmission originates from a TV broadcast, CATV system, satellite communication or a VCR (Video Cassette Recorder).

Three sides interact in the reception of digital data from a display device: a transmitter being the screen of a display device, a user, being the operator, and a receiver with at least one photo-sensor.

With reference to Tables 1 and 2, the interaction between the user 86, the transmitter T and the receiver R, during the communication process, will now be explained in more details. Tables 1 and 2 comprise each three columns designated as T, U and R, relating respectively, to the transmitter T, the user 86 or U, and to the receiver R.

TABLE 1
Transmission From Monitor to Screen

| | T: LCD SCREEN | U: USER | R: RECEIVER |
|---|---|---|---|
| 150 | | Activate RECEIVE and | RECEIVE activated |
| | | keep activated | and ready |
| 152 | | Keep RECEIVE | Emit RECEIVE |
| | | activated till notice | READY feedback |
| 154 | | Detect RECEIVING | Emit RECEIVE |
| | | READY feedback | READY feedback |
| 156 | TRANSMIT | Activate TRANSMIT | Emit RECEIVE |
| | activated | | READY feedback |
| 158 | TRANSMISSION | | Emit RECEIVE |
| | starts | | READY feedback |
| 160 | TRANSMISSION | Detect TRANSM- | Emit RECEIVE |
| | in operation | ISSION on screen | READY feedback |
| 162 | TRANSMISSION | Position receiver | Receiver opposite |
| | in operation | opposite screen | display. Emit |
| | | | RECEIVE READY |
| | | | feedback |
| 164 | TRANSMISSION | Wait for RECEIVING | Emit RECEIVE |
| | | signal | READY feedback |
| 166 | TRANSMISSION | | Emit RECEIVING |
| | | | feedback while rec. |
| | | | data |
| 168 | TRANSMISSION | Detect RECEIVING | Emit RECEIVING |
| | | signal Hold receiver in | feed-back while |
| | | position | receiving data |
| 170 | TRANSMISSION | Wait for TRANSMIS- | Emit RECEIVING |
| | | SION SUCCESSFUL | feed-back while |
| | | signal from receiver | receiving data |
| 172 | TRANSMISSION | | Emit |
| | | | TRANSMISSION |
| | | | SUCCESSFUL |
| | | | fdback |
| 174 | TRANSMISSION | Detect | Emit |
| | | TRANSMISSION | TRANSMISSION |
| | | SUCCESSFUL signal | SUCCESSFUL |
| | | feedback | |
| 176 | TRANSMISSION | Deactivate RECEIVE | RECEIVE |
| | | | deactivated |
| 178 | TRANSMISSION | Remove receiver | Receiver removed |
| 180 | Window closed, | Operate | |
| | transmission ends | “Close Window” | |
| 182 | TRANSMISSION | TRANSMISSION | TRANSMISSION |
| | END | END | END |

TABLE 2
Transmission from TV-Screen

| | T: TV-SCREEN | U: USER | R: RECEIVER |
|---|---|---|---|
| 190 | | Wait for TRANSMISSION | |
| | | warning | |
| 192 | TRANSMISSION | Detect warning from | |
| | IMMINENT warning | screen | |
| 194 | | Activate RECEIVE | RECEIVE activated |
| 196 | | | Emit RECEIVE |
| | | | READY fdback |
| 198 | | Detect RECEIVE READY signal | |
| 200 | | Position receiver | Receiver opposite TV |
| | | opposite TV screen | screen |
| 202 | | Wait for TV TRANSM. | |
| 204 | TRANSMISSION starts | | |
| 206 | TRANSMISSION | Detect TRANSMISSION | |
| | | from screen | |
| 208 | TRANSMISSION | Wait for RECEIVING sign. | |
| 210 | TRANSMISSION | | Emit RECEIVING feed- |
| | | | back while receiving data |
| 212 | TRANSMISSION | Detect RECEIVING | Emit RECEIVING |
| | | signal. | feedback while |
| | | Hold receiver in position | receiving data |
| 214 | TRANSMISSION | Wait for TRANSMISSION | Emit RECEIVING |
| | | SUCCESSFUL | feedback while |
| | | signal from receiver | receiving data |
| 216 | TRANSMISSION | | Emit TRANSMISSION |
| | | | SUCCESSFUL feedback |
| 218 | TRANSMISSION | Detect TRANSMISSION | |
| | | SUCCESSFUL signal | |
| 220 | | Deactivate RECEIVE | RECEIVE deactivated |
| 222 | | Remove receiver | Receiver removed |
| 224 | TRANSMISSION END | TRANSMISSION END | TRANSMISSN. END |

Each line in Tables 1 and 2 pertains to a step in the communication process, but it is noted that these numbers do not necessarily determine the order of operation. It is often possible to interchange the order of the steps of the transmission process. It is noted that a specific cell in the Tables 1 and 2, is designated by the intersection of a line and a column.

Table I depicts, for example, the steps for transmission of digital data from a screen 10 pertaining to a monitor 20 for a computer. It is assumed that the computer program that reads the strings of digital data for transmission and for display as dither patterns on the screen 10 is ready for operation, for example, after activation of the “load file” button 33.

In step 150 U, the user 86 activates the receive button 60 and keeps that button activated, which brings the receiver R to the activated and ready state for reception, as in step 150 R. This activation starts a feedback signal, in step 152 R that indicates, for example by a low frequency beep, that the receiver is ready for reception.

The user 86 must keep the receive button 60 activated during the digital data reception process, as by step 152 U, until permitted to deactivate that button.

Next, the user 86 is expected to detect the “receive ready” feedback signal in step 154U, and to respond thereto by activating the transmit button 30 in the transmission window 22, as by step 156 U. In the transmission window 22, the button 30 is now shown as being activated, see step 156 T, and the transmission of digital data starts immediately, as in step 158 T. With the transmission operative, in step 160 T, the user 86 is able to detect that transmission by the button 30 being shown as activated and by the flashes appearing in the transmission window 22, as in step 160 U.

It is now to the user to manipulate the receiver R into correct position in spatial relation with screen 10, and especially with the transmission window 22, by step 162 U and 162 R, in wait for the “receiving” feedback signal, step 164 U. comprising, for example, a high frequency beep sound.

When the receiver R finally receives the transmission from the transmitter T, the “receiving” feedback signal is emitted, as in step 166 R and replaces the “receive ready” feedback signal. It is noted that the low frequency “receive ready” feedback signal operated from step 152 R to step 164 R inclusive, thus until reception of the digital data transmission by the receiver R from the transmitter T.

After detection of the “receiving” feedback signal, in step 168 U, the user 86 “freezes” the position of the receiver R, waiting for the “transmission successful” feedback signal of step 170 U.

When the receiver, in step 172 R, emits the feedback signal indicating successful transmission, say a continuous beep, the “receiving” feedback signal, that was operative from step 166 R to 170 R inclusive, now ends, and the user 86 is expected to respond, in step 174 U, and to deactivate the “receive” button 60, as in step 176 U.

The receiver R responds thereto to the deactivation, in step 176 R, and the “transmission successful” feedback signal that sounded since step 172 R, is now ended. The user 86 removes the receiver R, in 178 U, resulting in the same for step 178 R at the receiver end. He then activates the “close window” button 32, in step 180 U, thereby bringing the digital data transmission, that lasted since step 158 T, to an end and to the closing of the transmission window 22, by step 180 T. The end of transmission is reached in line 182.

FIG. 15 is similar but simpler than FIG. 14 and does not require further explanations.

The transmission of digital data from a transmitter T to a receiver R requires the spatial positioning of the latter relative to the former. More specifically, the receiver R is best positioned opposite the “window”, which is the term defining either a transmission window 22, or a transmission port 34, or a TV window 36. This window appears on either but a portion or on the entire surface of a screen 10. As explained above, “screen” is the term defining any type of screen and even any derivation from a screen, optical or other.

It will be appreciated by persons skilled in the art, that the present invention is not limited to what has been particularly shown and described hereinabove. Rather, the scope of the present invention is defined by the appended claims and includes both combinations and sub-combinations of the various features described hereinabove as well as variations and modifications thereof which would occur to persons skilled in the art upon reading the foregoing description.

What is claimed is:

1. A transmission method for transmitting digital data from a transmitter to a receiver, the transmitter comprising a screen and the method comprising the steps of:
displaying the digital data on the screen as a first representation comprising at least one dither pattern, and
deriving from the screen a second representation representative of the first representation.

2. The transmission method according to claim 1, further comprising the step of:
selecting the screen from the group of screens consisting of CRT screens, LCD screens, OLED screens, backlit screens and plasma screens.

3. The transmission method according to claim 1, further comprising the step of:
displaying the at least one dither pattern with a predetermined level of luminance selected from the group consisting of a distribution spanning the range from 0% to 100% of luminance level.

4. The transmission method according to claim 1, further comprising the steps of:
configuring the first representation to comprise a predetermined level of luminance,
deriving the second representation from the first representation, the second representation being in linear proportion to the predetermined level of luminance of the first representation.

5. The transmission method according to claim 1, further comprising the step of:
configuring each one of the at least one dither pattern to represent at least one bit of data.

6. The transmission method according to claim 1, further comprising the step of:
configuring each one of the at least one dither pattern to represent at least two bits of data.

7. A transmission method for transmitting digital data from a transmitter to a receiver, the transmitter comprising a screen and the method comprising the steps of:
displaying the digital data on the screen as a succession of at least one pattern defining a first representation,
deriving from the screen a second representation representative of the first representation, and
configuring the at least one pattern of the first representation to comprise at least one dither pattern.

8. The transmission method according to claim 7, further comprising the step of:
selecting the screen from the group of screens consisting of CRT screens, LCD screens, OLED screens, backlit screens and plasma screens.

9. The transmission method according to claim 8, further-comprising the steps of:
integrating a low-pass-filter in the receiver for removal of high frequency scanning effects, and
enabling the receiver for reception of digital data from a screen selected from the group of screens.

10. The transmission method according to claim 7, further comprising the steps of:
deriving at least one image from the first representation, and
deriving the second representation from the at least one image.

11. The transmission method according to claim 7, comprising the steps of:
configuring each at least one dither pattern to comprise a predetermined level of luminance selected from the group consisting of a distribution spanning the range from 0% to 100% of luminance level, and
deriving the second representation in linear proportion to the predetermined level of luminance of each the at least one dither pattern.

12. The transmission method according to claim 7, further comprising the steps of:
configuring each at least one dither pattern to comprise a combination of M dither patterns, where M is at least 2,
carrying at least log₂ M bits of data in each the at least one dither pattern, and
displaying each the at least one dither pattern with a predetermined mutually different level of luminance selected from the group consisting of a distribution spanning the range from 0% to 100% of luminance level.

13. The transmission method according to claim 7, further comprising the step of:
configuring the first representation to comprise a combination of four dither patterns, each one of the four dither patterns carrying two bits of data, and
configuring each one of the four dither patterns with a predetermined mutually different level of luminance selected from the group consisting of a distribution spanning the range from 0% to 100% of luminance level.

14. The transmission method according to claim 7, further comprising the steps of:
configuring the first representation to comprise a combination of eight dither patterns, wherein each one of the eight dither patterns carries three bits of data, and
configuring each one of the eight dither patterns with a mutually different level of luminance selected from the group consisting of a distribution spanning the range from 0% to 100% of luminance level.

15. The transmission method according to claim 7, further comprising the steps of:
defining the screen as an entire display surface, and
configuring the entire display surface for display of the at least one first representation.

16. The transmission method according to claim 15, further comprising the steps of:
defining the first representation to comprise more than one first representation, and
configuring the entire display surface for simultaneous display of more than one first representation.

17. The transmission method according to claim 15, further comprising the steps of:
defining a first portion of the screen to comprise a window and defining a second portion of the screen to comprise an area,
configuring the window for display of the at least one first representation,
configuring the area for display of one presentation, and
configuring the screen for simultaneously display of the at least one first representation in the window and of the one presentation in the area.

18. The transmission method according to claim 17, further comprising the steps of:
defining a first portion of the screen to comprise a predetermined number of windows, and
defining a second portion of the screen to comprise a preset number of areas,
defining a number of first representations to equal the predetermined number of windows, and defining a number of presentations to equal the preset number of areas,
configuring each one of the predetermined number of windows for simultaneous display of, respectively, one of the number of first representations and configuring each one of the preset number of areas for simultaneous display of, respectively, one of the number of presentations, and
displaying simultaneously the number of first representations in the first portion of the screen, and displaying simultaneously the number of presentations in the second portion of the screen.

19. The transmission method according to claim 7, further comprising the step of:
operating the transmitter and the receiver, in combination, in either one of two configurations consisting of a static configuration and a portable configuration.

20. The transmission method according to claim 7, further comprising the step of:
implementing the transmitter to be static and the receiver to be portable.

21. The transmission method according to claim 7, further comprising the step of:
implementing both the transmitter and the receiver to be portable.

22. The transmission method according to claim 7, further comprising the step of:
providing the receiver with a feedback signal emission mechanism for confirmation of operation of the transmitter in association with the receiver.

23. The transmission method according to claim 22, further comprising the step of:
operating at least one transmission phase from the transmitter to the receiver, and
associating a mutually different feedback signal with each at least one transmission phase.

24. A transmitter comprising a processor coupled to a memory storing a processor-readable program and a screen coupled to and driven by the processor for display of digital data originating from a data source, for transmission via the screen of the digital data to a receiver comprising a photo-sensor, and the transmitter comprising:
a first representation of the digital data configured for display on the screen,
a second representation of the digital data being derived by the receiver from the screen, the second representation being representative of the first representation, and
the first representation comprising at least one dither pattern.

25. The transmitter according to claim 24, further comprising:
the screen being selected from the group of screens consisting of CRT screens, LCD screens, OLED screens, backlit screens and plasma screens.

26. The transmitter according to claim 24, wherein the at least one dither pattern comprises:
a predetermined level of luminance selected from the group consisting of a distribution spanning the range from 0% to 100% of luminance level.

27. The transmitter according to claim 24, wherein
the first representation comprises a predetermined level of luminance, and
the second representation is in linear proportion to the predetermined level of luminance of the first representation.

28. The transmitter according to claim 24, further comprising:
each one of the at least one dither pattern representing at least one bit of data.

29. The transmitter according to claim 24, further comprising:
each one of the at least one dither pattern representing at least two bits of data.

30. A transmitter apparatus comprising a processor coupled to a memory storing a processor-readable program and a screen coupled to and driven by the processor for display of digital data originating from a data source, for transmission via the screen of the digital data to a receiver comprising a photo-sensor, and the transmitter comprising:
at the transmitter:
a first representation of the digital data configured for display on the screen as a succession of at least one pattern, and
at the receiver:
a second representation being derived from the screen and being representative of the first representation, and
the first representation being configured to comprise at least one dither pattern.

31. The transmission apparatus according to claim 30, wherein:
the screen is selected from the group of screens consisting of CRT screens, LCD screens, OLED screens, backlit screens and plasma screens.

32. The transmission apparatus according to claim 31, further comprising:
a low-pass-filter being integrated in the receiver for removal of high frequency scanning effects,
to enable reception of digital data from a screen selected from the group of screens.

33. The transmission apparatus according to claim 30, further comprising:
at least one image being derived from the first representation, and
the second representation being derived from the at least one image.

34. The transmission apparatus according to claim 30, wherein:
each at least one dither pattern is configured to comprise a predetermined level of luminance selected from the group consisting of a distribution spanning the range from 0% to 100% of luminance level, and
the second representation is in linear proportion to the predetermined level of luminance of each the at least one dither pattern.

35. The transmission apparatus according to claim 30, wherein:
each at least one dither pattern of the first representation comprises a combination of M dither patterns, where M is at least 2,
each the at least one dither pattern carries at least log₂ M bits of data, and
each the at least one dither pattern is configured with a predetermined mutually different level of luminance selected from the group consisting of a distribution spanning the range from 0% to 100% of luminance level.

36. The transmission of levels of luminance apparatus according to claim 30, wherein:
the first representation comprises a combination of four dither patterns, where each one of the four dither patterns carries two bits of data, and each one of the four dither patterns is configured with a predetermined mutually different level of luminance selected from the group consisting of a distribution spanning the range from 0% to 100% of luminance level.

37. The transmission apparatus according to claim 30, wherein:
the first representation comprises a combination of eight dither patterns, where each one of the eight dither patterns carries three bits of data, and each one of the eight dither patterns is configured with a predetermined mutually different level of luminance selected from the group consisting of a distribution spanning the range from 0% to 100% of luminance level.

38. The transmission apparatus according to claim 30, wherein:
the screen defines an entire display surface, and
the entire display surface is configured for display of the at least one first representation.

39. The transmission apparatus according to claim 38, wherein:
the first representation is defined to comprise more than one first representation, and
the entire display surface is configured for simultaneous display of more than one first representation.

40. The transmission apparatus according to claim 38, further comprising:
a first portion of the screen being defined to comprise a window and a second portion of the screen being defined to comprise an area,
the window being defined for display of the first representation,
the area being configured for display of one presentation, and
the screen being configured for simultaneously display of the at least one representation in the window and of the one presentation in the area.

41. The transmission apparatus according to claim 40, further comprising:
a first portion of the screen being defined to comprise a predetermined number of windows, and
a second portion of the screen being defined to comprise a preset number of areas,
a number of first representations being set to equal the predetermined number of windows, and
a number of presentations being set to equal the preset number of areas,
each one of the predetermined number of windows being configured for simultaneous display of, respectively, one first representation, and each one of the preset number of areas being configured for simultaneous display, respectively, of one presentation,
whereby display of the predetermined number of first representations is achieved in the first portion of the screen simultaneously with display of the preset number of presentations in the second portion of the screen.

42. The transmission apparatus according to claim 30, further comprising:
the transmitter and the receiver operating, in combination, in either one of two configurations consisting of a static configuration and a portable configuration.

43. The transmission apparatus according to claim 30, further comprising:
the transmitter being static and the receiver being portable.

44. The transmission apparatus according to claim 30, further comprising:
the transmitter and the receiver being both portable.

45. The transmission apparatus according to claim 30, further comprising:
the receiver being provided with a feedback signal emission mechanism for confirmation of operation of the transmitter in association with the receiver.

46. The transmission apparatus according to claim 45, further comprising:
at least one operative transmission phase, and
a mutually different feedback signal being associated with each at least one transmission phase.

47. A system comprising a transmitter with a screen operating in association with a receiver comprising a photo-sensor positioned in front of and in a field of view of the screen, the receiver receiving digital data displayed on the screen, the system comprising:
a first representation of the digital data being displayed on the screen,
a second representation of the digital data being derived by the receiver from the screen, the second representation being representative of the first representation, and
the first representation comprising at least one dither pattern.

48. The transmission system according to claim 47, further comprising:
the screen is selected from the group of screens consisting of CRT screens, LCD screens, OLED screens, backlit screens and plasma screens.

49. The transmission system according to claim 47, wherein:
the dither pattern further comprises a predetermined level of luminance selected from the group consisting of a distribution spanning the range from 0% to 100% of luminance level.

50. The transmission system according to claim 47, wherein
the first representation comprises a predetermined level of luminance, and
the second representation is linearly proportional to the predetermined level of luminance of the first representation.

51. The transmission system according to claim 47, wherein:
each one of the at least one dither pattern representing at least one bit of data.

52. The transmission system according to claim 47, wherein:
each one of the at least one dither pattern representing at least two bits of data.

53. A system comprising a transmitter with a screen operating in association with a receiver comprising a photo-sensor positioned in front of and in a field of view of the screen, the receiver receiving digital data displayed on the screen, the system comprising:
at the transmitter:
a first representation of the digital data configured for display on the screen as a succession of patterns, and
at the receiver:
a second representation being derived from the screen and being representative of the first representation,
the first representation being configured as a succession of dither patterns.

54. The transmission system according to claim 53, further comprising:
the screen being selected from the group of screens consisting of CRT screens, LCD screens, OLED screens, backlit screens and plasma screens.

55. The transmission system according to claim 54, wherein the receiver further comprises:
a low-pass-filter for removal of high frequency scanning effects, the low-pass-filter enabling reception of digital data from a screen selected from the group of screens.

56. The transmission system according to claim 53, further comprising:
at least one image derived from the first representation on the screen, and
the second representation being derived from the at least one image.

57. The transmission system according to claim 53, wherein:
each at least one dither pattern being configured to comprise a predetermined level of luminance selected from the group consisting of a distribution spanning the range from 0% to 100% of luminance level, and
the second representation being in linear proportion to the predetermined level of luminance of each the at least one dither pattern.

58. The transmission system according to claim 53, wherein:
each at least one dither pattern of the first representation comprises a combination of M dither patterns, where M is at least 2,
each the at least one dither pattern carries at least log₂ M bits of data, and
each the at least one dither pattern displays a predetermined mutually different level of luminance selected from the group consisting of a distribution spanning the range from 0% to 100% luminance level.

59. The transmission system according to claim 53, wherein:
the first representation comprising a combination of four dither patterns, wherein each one of the four dither patterns carries two bits of data, and each one of the four dither patterns is configured with a predetermined mutually different level of luminance selected from the group consisting of a distribution spanning the range from 0% to 100% of luminance level.

60. The transmission system according to claim 53, wherein:
the first representation comprising a combination of eight dither patterns, wherein each one of the eight dither patterns carries three bits of data, and each one of the eight dither patterns is configured with a predetermined mutually different level of luminance selected from the group consisting of a distribution spanning the range from 0% to 100% of luminance level.

61. The transmission system according to claim 53, further comprising:
the screen defining an entire display surface, and
the entire display surface being configured for display of the at least one first representation.

62. The transmission system according to claim 61, further comprising:
the first representation being defined to comprise more than one first representation, and
the entire display surface being configured for simultaneous display of more than one first representation.

63. The transmission system according to claim 61, further comprising:
a first portion of the screen being defined to comprise a window and a second portion of the screen being defined to comprise an area,
the window being defined for display of the first representation,
the area being configured for display of one presentation, and
the screen being configured for simultaneously display of the first representation in the window, and of the one presentation in the area.

64. The transmission system according to claim 63, further comprising:
a first portion of the screen being defined to comprise a predetermined number of windows,
a second portion of the screen being defined to comprise a preset number of areas,
a number of first representations being set to equal the predetermined number of windows,
a number of presentations being set to equal the preset number of areas,
each one of the predetermined number of windows being configured for simultaneous display of, respectively, one first representation, and
each one of the preset number of areas being configured for simultaneous display, respectively, of one presentation,
whereby display of the predetermined number of first representations is achieved in the first portion of the screen simultaneously with display of the preset number of presentations in the second portion of the screen.

65. The transmission system according to claim 53, wherein
the transmitter and the receiver operate, in combination, in either one of two configurations consisting of a static configuration and a portable configuration.

66. The transmission system according to claim 53, wherein
the transmitter is static and the receiver is portable.

67. The transmission system according to claim 53, wherein
the transmitter and the receiver are both portable.

68. The transmission system according to claim 53, further comprising:
a feedback signal emission mechanism being integrated within the receiver to provide confirmation of operation of the transmitter in association with the receiver.

69. The transmission system according to claim 68, further comprising:
at least one operative transmission phases, and
a mutually different feedback signal being associated with each at least one operative transmission phase.
